(19) United States
(12) Patent Application Publication
(10) Pub. No.: US 2015/0008680 A1
(43) Pub. Date: Jan. 8, 2015

(54) INTERIOR APPARATUS OF A VEHICLE

(71) Applicant: Junya Suzuki, Toyota-shi (JP)

(72) Inventor: Junya Suzuki, Toyota-shi (JP)

(73) Assignee: KOJIMA PRESS INDUSTRY CO., LTD., Toyota-shi (JP)

(21) Appl. No.: 14/376,645

(22) PCT Filed: Aug. 2, 2012
(86) PCT No.: PCT/JP2012/069643

§ 371 Date: Aug. 5, 2014

(30) Foreign Application Priority Data
Feb. 6, 2012 (JP) 2012-023005

(51) Int. Cl. E05C 1/08

(52) U.S. Cl. CPC E05C 1/08
USPC 292/32

(57) ABSTRACT

A lock device includes a holding structure for holding a state that the ends of the first and second rods have been withdrawn from the first and second lock-receiving portions. Therefore, when a movable member is moved from an open positioner to a closed position, it is possible to prevent the first and second rods from contacting with a fixed member and being pushed by the fixed member. Therefore, a force which will occur if the first and second rods are brought into contact with the fixed member and are pushed by the fixed member does not occur. As a result, when the movable member is closed, it is possible to improve an operating feeling compared with that of a conventional interior apparatus of a vehicle.

### TECHNICAL FIELD

The present invention relates to an interior apparatus of a vehicle, for example, a glove box of a vehicle.

### BACKGROUND

FIGS. 23 and 24 illustrate a conventional glove box of a vehicle as a conventional interior apparatus of a vehicle 1. The interior apparatus of a vehicle 1 includes a fixed member 2, a movable member 3, a lock device 4 and a cushion rubber 6.

The movable member 3 is movable relative to the fixed member 2 between an open position and a closed position.
The lock device 4 includes a pair of rods 4a, 4a including first and second rods provided at the movable member 3, and a pair of lock-receiving portions 4b, 4b including first and second lock-receiving portions provided at the fixed member 2 such that ends of the first and second rods are moved into and out from the first and second lock-receiving portions, respectively.
The cushion rubber 6 is provided in order to suppress the movable member 3 from rattling relative to the fixed member 2 when the movable member 3 is at the closed position (shown in continuous line in FIG. 24) and when the vehicle runs.

As illustrated in FIG. 23, when the movable member 3 is moved from the open position to the closed position (in direction C in FIG. 23), an inclined surface 4c provided at an end of each of the first and second rods 4a, 4a is brought into contact with the fixed member 2 whereby the first and second rods 4a, 4a are pushed by the fixed member 2. As illustrated in FIG. 24, when the movable member 3 arrives at the closed position, the ends of the first and second rods 4a, 4a are moved into the first and second lock-receiving portions, respectively. When the movable member 3 arrives at the closed position, the cushion rubber 6 is compressed and deformed by the fixed member 2 and the movable member 3.

However, there are the following problems with the conventional interior apparatus of a vehicle 1:

When the movable member 3 is moved from the open position to the closed position (i.e., when the movable member 3 is closed), two steps of forces occur. One is a force which is generated when the inclined surfaces 4c of the first and second rods 4a, 4a are brought into contact with the fixed member 2 whereby the first and second rods 4a, 4a are pushed by the fixed member 2, and the other is a force which is generated when the cushion rubber 6 is compressed and deformed. Therefore, the conventional interior apparatus of a vehicle has a problem that an operating feeling is desirable to be improved when the movable member 3 is closed.

### PRIOR ART DOCUMENT

### Patent Document

Patent Document 1: JP2009-138407

### BRIEF SUMMARY

An object of the invention is to provide an interior apparatus of a vehicle which can improve an operating feeling compared with that of the conventional interior apparatus of a vehicle when a movable member is closed.

### Means for Solving the Problems

The present invention can achieves the above object is as follows:

### (1) Embodiments 1 and 2

An interior apparatus of a vehicle comprising a fixed member, a movable member movable relative to the fixed member between an open position and a closed position, and a lock device for locking and unlocking the movable member to and from the fixed member when the movable member is at the closed position.

The lock device includes a pair of rods, a synchronizing structure, a pair of lock-receiving portions, a biasing member and a holding structure.

The pair of rods includes first and second rods, provided at the movable member and extending in a rod-extending direction.

The synchronizing structure synchronizes the first and second rods such that the first and second rods are moved in opposite directions to each other in the rod-extending direction.

The pair of lock-receiving portions includes first and second lock-receiving portions, provided at the fixed member such that ends of the first and second rods are moved into and out from the first and second lock-receiving portions, respectively.

The biasing member biases the first and second rods in opposite directions in which the ends of the first and second rods are moved into the first and second lock-receiving portions, respectively.

The holding structure holds a state that the ends of the first and second rods are withdrawn from the first and second lock-receiving portions, when the first and second rods have been pulled against a biasing force of the biasing member whereby the ends of the first and second rods have been withdrawn from the first and second lock-receiving portions, respectively.

### (2) Embodiments 1 and 2

An interior apparatus of a vehicle according to item (1) above, wherein the holding structure includes an engagement portion provided at at least one of the first and second rods. The holding structure includes an engagement-receiving portion provided at the movable member. The engagement portion is capable of engaging with and disengaging from the engagement-receiving portion. The holding structure includes a movement structure for moving a rod at which the engagement portion is provided in a direction different from the rod-extending direction and in a direction in which the engagement portion and the engagement-receiving portion are brought into engagement with each other when the first and second rods are being withdrawn from the first and second lock-receiving portions, respectively.

### (3) Embodiments 1 and 2

An interior apparatus of a vehicle according to item (2) above, wherein the lock device further includes a releasing structure for releasing a holding state by the holding structure, by moving the rod at which the engagement portion is provided in a direction in which engagement of the engagement portion with the engagement-receiving portion is released, when the movable member is being moved from the open position to the closed position.

### (4) Embodiments 1 and 2

An interior apparatus of a vehicle according to item (3) above, wherein the releasing structure includes a first releasing structure element provided at the rod at which the engagement portion is provided and a second releasing structure element provided at the fixed member. The second releasing structure element is brought into contact with the first releasing structure element when the movable member is being moved from the open position to the closed position.

### (5) Embodiments 1 and 2

An interior apparatus of a vehicle according to any one of items (2)-(4) above, wherein the engagement portion of the holding structure is provided only at one of the pair of rods. The lock device further includes a displacement structure for displacing the other of the pair of rods at which the engagement portion is not provided in a direction different from the rod-extending direction relative to the movable member, while the ends of the first and second rods have been withdrawn from the first and second lock-receiving portions against a biasing force of the biasing member.

### (6) Embodiment 1

An interior apparatus of a vehicle according to any one of items (2)-(5) above, wherein the movement structure of the holding structure includes a first movement structure element elastically deformably provided at one of the rod and the movable member and a second movement structure element provided at the other of the rod and the movable member, where the engagement portion is provided at the rod and the engagement-receiving portion is provided at the movable member. By causing the first movement structure element to slide onto the second movement structure element, the rod at which the engagement portion is provided is moved in the direction different from the rod-extending direction and in the direction in which the engagement portion is engaged with the engagement-receiving portion.

### (7) Embodiment 1

An interior apparatus of a vehicle according to items 3 or 4 above, wherein the rod at which the engagement portion is provided is moved by the movement structure of the holding structure in a direction perpendicular to direction D1 in which the movable member is moved relative to the fixed member when the movable member is moved from the open position to the closed position and arrives at the closed position. The rod at which the engagement portion is provided is moved by the releasing structure in the direction perpendicular to the direction D1 whereby the holding state by the holding structure is released by the releasing structure. A space exists between the fixed member and the rod at which the engaging portion is provided when the holding state by the holding structure is released by the releasing structure.

### (8) Embodiment 2

An interior apparatus of a vehicle according to any one of items (2)-(5) above, wherein the lock device further includes a push-type knob provided at the movable member. The movement structure of the holding structure includes a first rotational structure element provided at the rod at which the engagement portion is provided and a second rotational structure element provided at the push-type knob. The rod at which the engagement portion is provided is rotated by an operating force added on the knob in a direction in which the engagement portion and the engagement-receiving portion are engaged with each other.

### Technical Advantages

According to the interior apparatus of a vehicle of item (1) above, since the lock device includes a holding structure for holding a state that the ends of the first and second rods are withdrawn from the first and second lock-receiving portions, when the first and second rods have been pulled against a biasing force of the biasing member whereby the ends of the first and second rods have been withdrawn from the first and second lock-receiving portions, respectively, the following technical advantages can be obtained:

When the movable member is moved from the open position to the closed position (when the movable member is closed), it is possible to prevent the first and second rods from contacting with the fixed member and being pushed by the fixed member. Therefore, a force which will be generated if the first and second rods are brought into contact with the fixed member and pushed by the fixed member does not occur. As a result, it is possible to improve an operating feeling compared with that of the conventional interior apparatus of a vehicle.

According to the interior apparatus of a vehicle of item (2) above, since the holding structure includes the movement structure for moving the rod at which the engagement portion is provided in the direction different from the rod-extending direction and in the direction in which the engagement portion and the engagement-receiving portion are brought into engagement with each other when the first and second rods are being withdrawn from the first and second lock-receiving portions, respectively, the following technical advantages can be obtained:

By only withdrawing the first and second rods from the first and second lock-receiving portions, the engagement portion and the engagement-receiving portion can be brought into engagement with each other. Therefore, operability of the interior apparatus of a vehicle can be improved, compared with a case where further operation for causing the engagement portion and the engagement-receiving portion to engage with each other is required in addition to the operation of withdrawing the first and second rods from the first and second lock-receiving portions.

According to the interior apparatus of a vehicle of item (3) above, since the lock device further includes the releasing structure for releasing the holding state by the holding structure, by moving the rod at which the engagement portion is provided in the direction in which engagement of the engagement portion with the engagement-receiving portion is released, when the movable member is being moved from the open position to the closed position, the following technical advantages can be obtained:

By only causing the movable member to move from the open position to the closed position, the holding state by the holding structure can be released. Therefore, operability of the interior apparatus of a vehicle can be improved, compared with a case where further operation for causing to release the holding state by the holding structure is required in addition to the operation for closing the movable member.

According to the interior apparatus of a vehicle of item (4) above, since the releasing structure includes the first releasing structure element provided at the rod at which the engagement portion is provided and the second releasing structure element provided at the fixed member and since the second releasing structure element is brought into contact with the first releasing structure element when the movable member is being moved from the open position to the closed position, the following technical advantages can be obtained:

By causing the first releasing structure element and the second releasing structure element to contact with each other, the rod at which the engagement portion is provided can be moved in the direction in which engagement of the engagement portion with the engagement-receiving portion is released.

According to the interior apparatus of a vehicle of item (5) above, since the lock device further includes the displacement structure for displacing the other of the pair of rods at which the engagement portion is not provided in the direction different from the rod-extending direction relative to the movable member, while the ends of the first and second rods have been withdrawn from the first and second lock-receiving portions against the biasing force of the biasing member, the following technical advantages can be obtained: When the movable member is moved from the open position toward the closed position and has arrived at the closed position, even in a case where the rod at which the engagement portion is not provided is displaced from the lock-receiving portion due to a torsion of the movable member, an amount of the displacement can be decreased by a displacement amount of the rod at which the engagement portion is not provided, due to the displacement structure. Therefore, the rod at which the engagement portion is not provided can be surely moved into the lock-receiving portion, compared with a case where the lock device does not have the displacement structure.

According to the interior apparatus of a vehicle of item (6) above, (i) since the movement structure of the holding structure includes the first and second movement structure elements, and (ii) since by causing the first movement structure element to slide onto the second movement structure element, the rod at which the engagement portion is provided is moved in the direction different from the rod-extending direction and in the direction in which the engagement portion is engaged with the engagement-receiving portion, the following technical advantages can be obtained:

The engagement portion and the engagement-receiving portion can surely be engaged with each other by a relatively simple structure.

According to the interior apparatus of a vehicle of item (7) above, (i) since the rod at which the engagement portion is provided is moved by the movement structure of the holding structure in a direction perpendicular to direction D1, (ii) since the rod at which the engagement portion is provided is moved by the releasing structure in the direction perpendicular to the direction D1 whereby the holding state of the holding structure is released by the releasing structure, and (iii) since a space exists between the fixed member and the rod at which the engaging portion is provided when the holding state by the holding structure is released by the releasing structure, the following technical advantages can be obtained:

The rod at which the engagement portion is provided can be moved in direction D1 in the space relative to the fixed member after the holding state of the holding structure is released by the releasing structure. Therefore, even in a case where the movable member is moved rapidly from the open position to the closed position relative to the fixed member, the rod at which the engagement portion is provided is prevented from contacting with the fixed member so that movement of the movable member from open position to the closed position is not obstructed, after the holding state of the holding structure is released by the releasing structure.

According to the interior apparatus of a vehicle of item (8) above, since the movement structure of the holding structure includes the first and second rotational structure elements, and since the rod at which the engagement portion is provided is rotated by the operating force added on the knob in the direction in which the engagement portion and the engagement-receiving portion are engaged with each other, the following technical advantages can be obtained:

By only operating the push-type knob, the engagement portion and the engagement-receiving portion can surely be engaged with each other by a relatively simple structure.

### BRIEF DESCRIPTION OF THE DRAWINGS

FIG. 1 is a schematic front perspective view of an interior apparatus of a vehicle according to Embodiment 1 of the present invention, when a movable member is at a closed position. FIG. 1 is also applicable to Embodiment 2 of the present invention.

FIG. 2 is a cross-sectional view of the interior apparatus of a vehicle according to Embodiment 1 of the present invention, when the movable member is at the closed position. FIG. 2 is also applicable to Embodiment 2 of the present invention.

FIG. 3 is a partial perspective view of disassembled parts of a lock device, of the interior apparatus of a vehicle according to Embodiment 1 of the present invention.

FIG. 4 is a partial perspective view of the lock device, of the interior apparatus of a vehicle according to Embodiment 1 of the present invention.

FIG. 5 is a partial rear view of the lock device, of the interior apparatus of a vehicle according to Embodiment 1 of the present invention.

FIG. 6 is a perspective view of a first rod of the lock device, of the interior apparatus of a vehicle according to Embodiment 1 of the present invention, in a state where the first rod extends straight in a rod-extending direction.

FIG. 7 is a perspective view viewed from a side different from FIG. 6, of the first rod of the lock device, of the interior apparatus of a vehicle according to Embodiment 1 of the present invention, in the state where the first rod extends straight in the rod-extending direction.

FIG. 8 is a cross-sectional view of the interior apparatus of a vehicle according to Embodiment 1 of the present invention taken along line A-A in FIG. 5, when the movable member is at the closed position and the push-type knob is not operated.

FIG. 9 is an enlarged view of the first rod and its vicinity in FIG. 8.

FIG. 10 is an enlarged view of the first rod and its vicinity of the interior apparatus of a vehicle according to Embodiment 1 of the present invention, when the push-type knob is operated to change from a state of FIG. 8.

FIG. 11 is an enlarged view of the first rod and its vicinity of the interior apparatus of a vehicle according to Embodiment 1 of the present invention, when the movable member is moved from an open position to the closed position and the first rod is moved in a direction in which engagement of an engagement portion with an engagement-receiving portion is released by a releasing structure.

FIG. 12 is a cross-sectional view of the interior apparatus of a vehicle according to an alteration of Embodiment 1 of the present invention, in a case where the lock device includes a displacement structure, and when the movable member is at the closed position and the push-type knob is not operated.

FIG. 13 is a cross-sectional view of the interior apparatus of a vehicle according to the alteration of Embodiment 1 of the present invention, when the knob is operated to change from a state of FIG. 12.

FIG. 14 is a partial cross-sectional view of the interior apparatus of a vehicle according to a second alteration of Embodiment 1 of the present invention, in a case where the first rod is moved in a direction perpendicular to direction D1 by a movement structure of a holding structure and the releasing structure, and when a holding state by the holding structure is released by the releasing structure so that the first and second rods are moved into first and second lock-receiving portions, respectively.

FIG. 15 is a cross-sectional view of the apparatus of FIG. 14 taken along line B-B in FIG. 14.

FIG. 16 is a cross-sectional view of the apparatus of FIG. 14 taken along line B-B in FIG. 14, when the holding state by the holding structure is released by the releasing structure and the first rod is moved in direction D1 in a space relative to a fixed member.

FIG. 17 is a partial perspective view of disassembled parts of a lock device, of an interior apparatus of a vehicle according to Embodiment 2 of the present invention.

FIG. 18 is a partial perspective view of the lock device, of the interior apparatus of a vehicle according to Embodiment 2 of the present invention, where a second rod is omitted in order to clarify the view.

FIG. 19 is a partial perspective view of the lock device viewed from a side different from FIG. 18, of the interior apparatus of a vehicle according to Embodiment 2 of the present invention, where the second rod is omitted in order to clarify the view.

FIG. 20 is a partial perspective view of the lock device of the interior apparatus of a vehicle according to Embodiment 2 of the present invention, where the second rod is omitted in order to clarify the view, and where

(a) illustrates a state where a movable member is at a closed position and a knob is not operated, and
(b) illustrates a state where the knob is operated, first and second rods are withdrawn from first and second lock receiving portions, respectively, and the first rod is rotated in a direction in which an engagement potion and an engagement-receiving portion are engaged by a holding structure.

FIG. 21 is a partial perspective view viewed from a side different from FIG. 20, of the lock device of the interior apparatus of a vehicle according to Embodiment 2 of the present invention, where the second rod is omitted in order to clarify the view, and where

(a) illustrates the state where the movable member is at the closed position and the knob is not operated,
(b) illustrates the state where the knob is operated, the first and second rods are withdrawn from the first and second lock receiving portions, respectively, and the first rod is rotated in the direction in which the engagement potion and the engagement-receiving portion are engaged by the holding structure.

FIG. 22 is an enlarged cross-sectional view of a releasing structure, of the interior apparatus of a vehicle according to Embodiment 2 of the present invention, when the movable member is moved from an open position to the closed position and the first rod is rotated in a direction in which engagement of the engagement potion with the engagement-receiving portion is released by the releasing structure.

FIG. 23 is a cross-sectional view of a conventional interior apparatus of a vehicle, when a movable member is moved from an open position to a closed position and inclined surfaces of a first rod and a second rod are brought into contact with a fixed member.

FIG. 24 is a cross-sectional view of the conventional interior apparatus of a vehicle, when the movable member is further moved than in FIG. 23 and the movable member has arrived at the closed position.

### DETAILED DESCRIPTION OF THE PREFERRED EMBODIMENTS

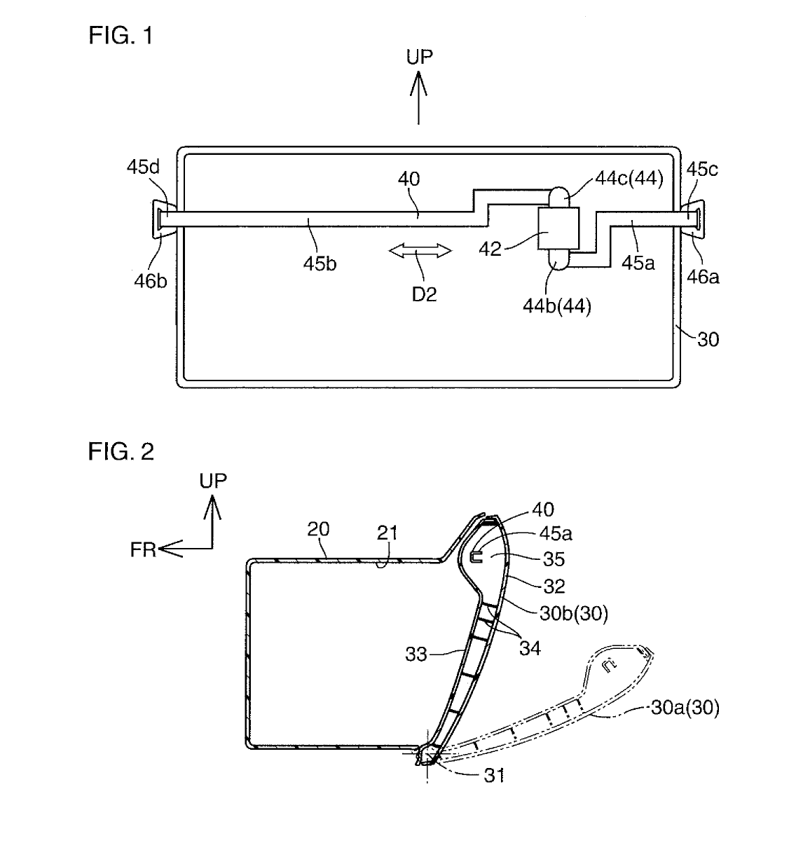

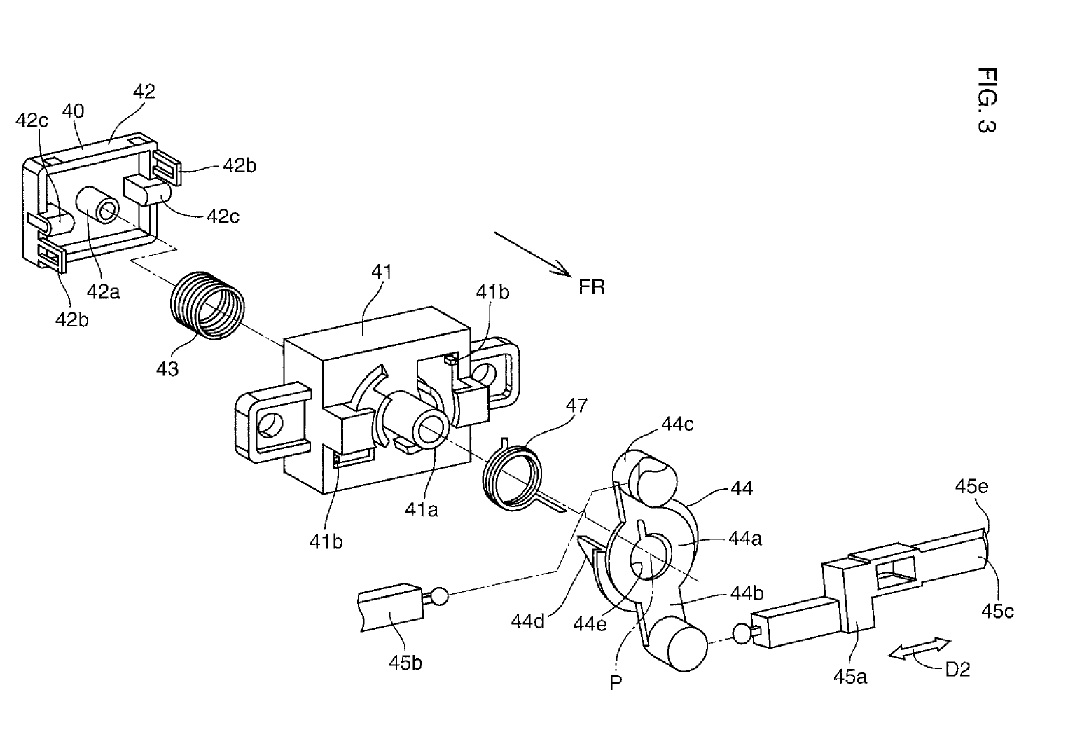

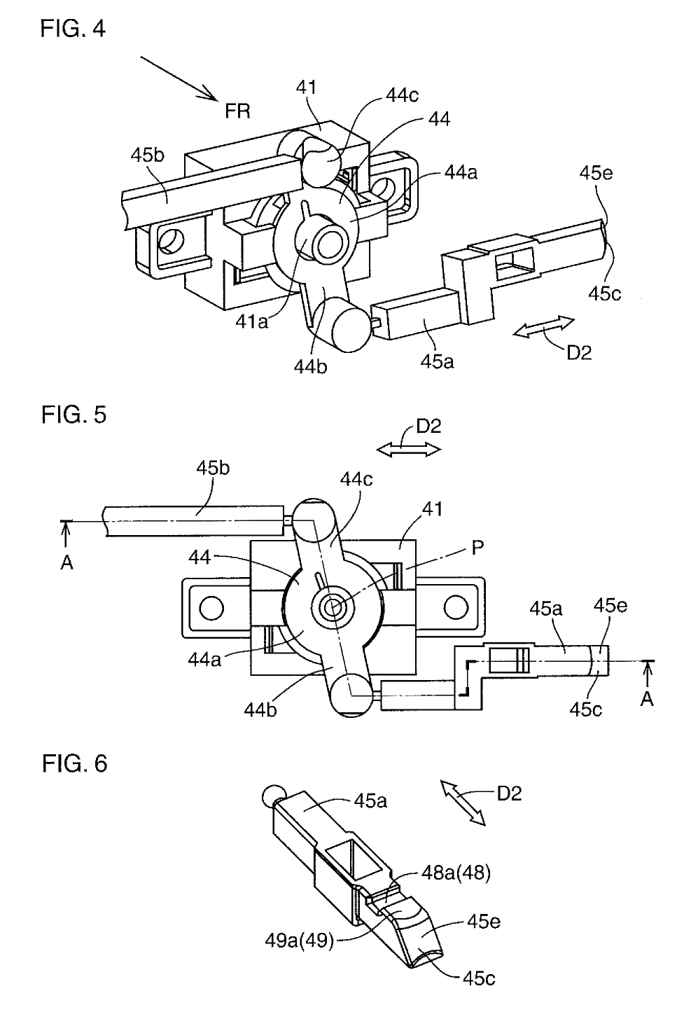

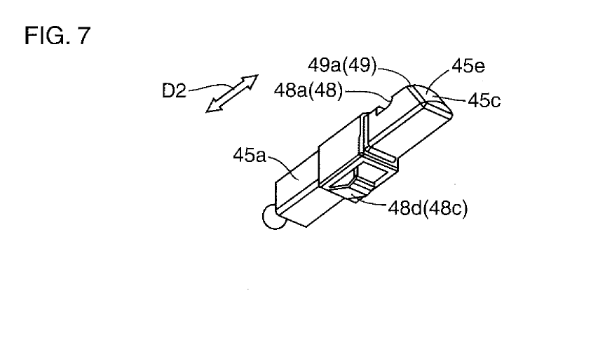

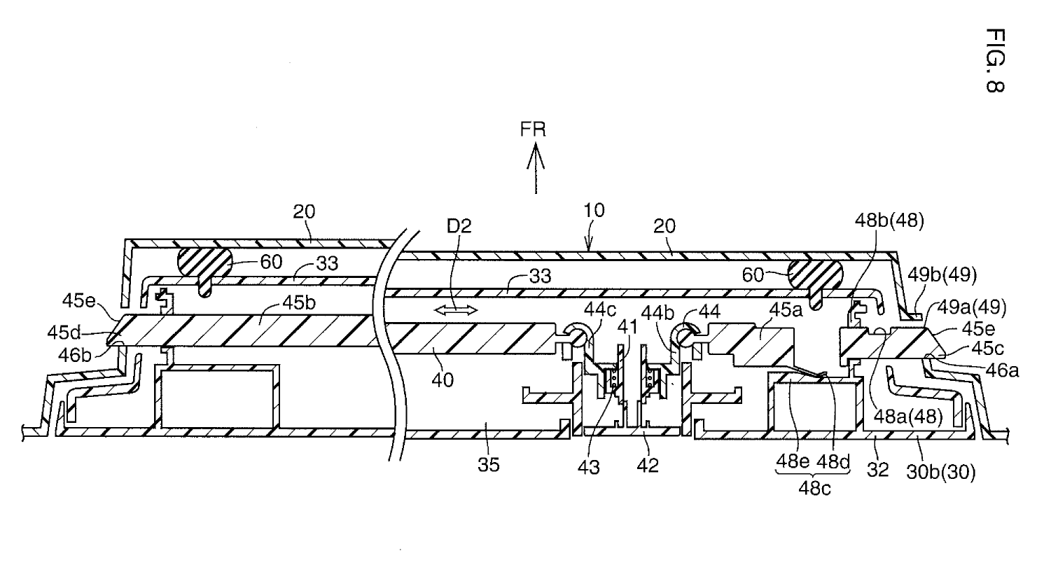

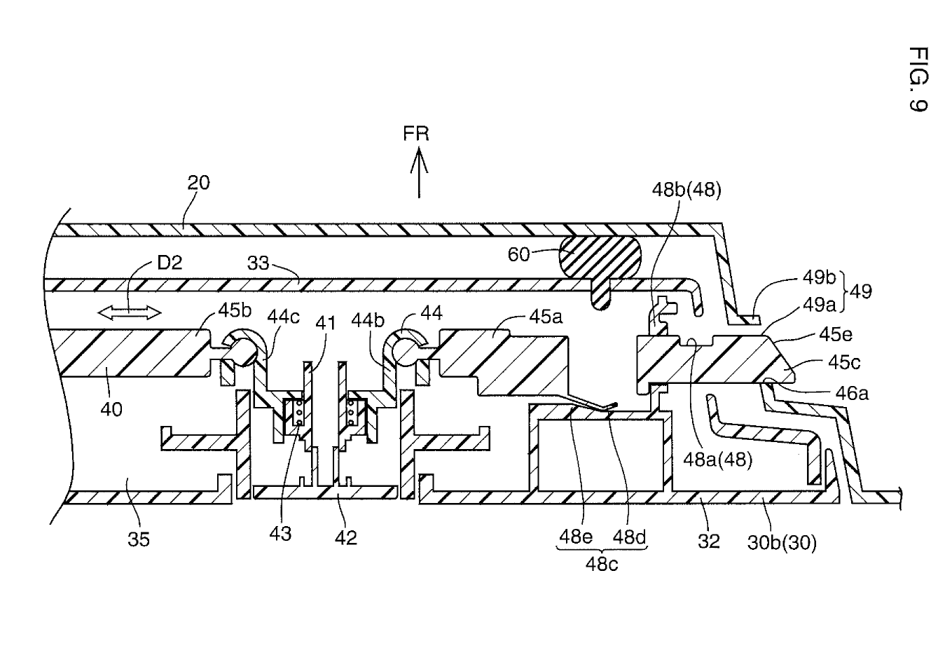

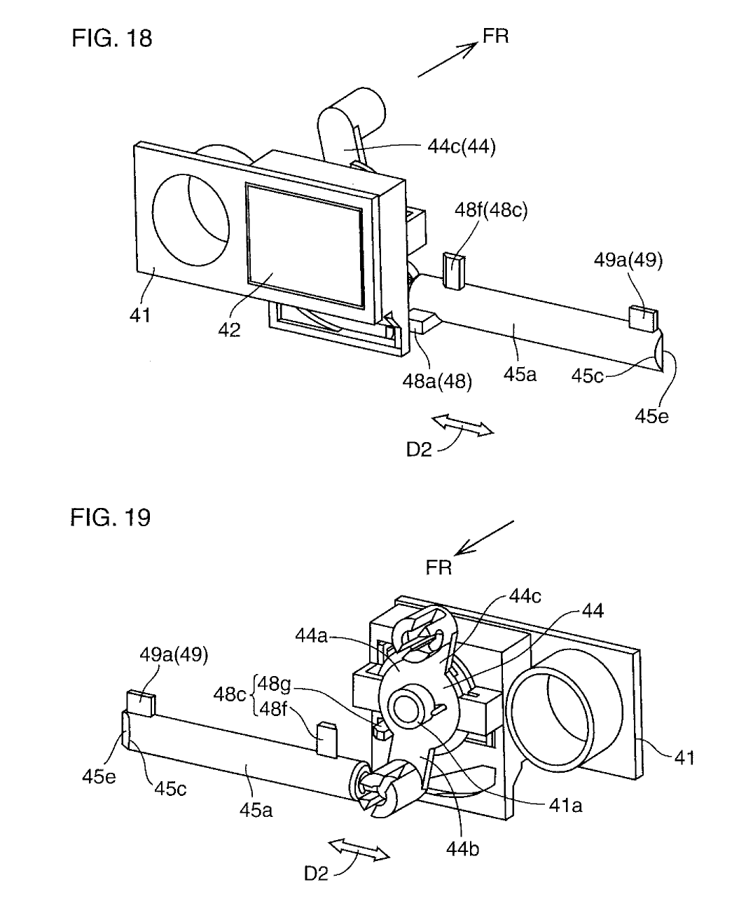

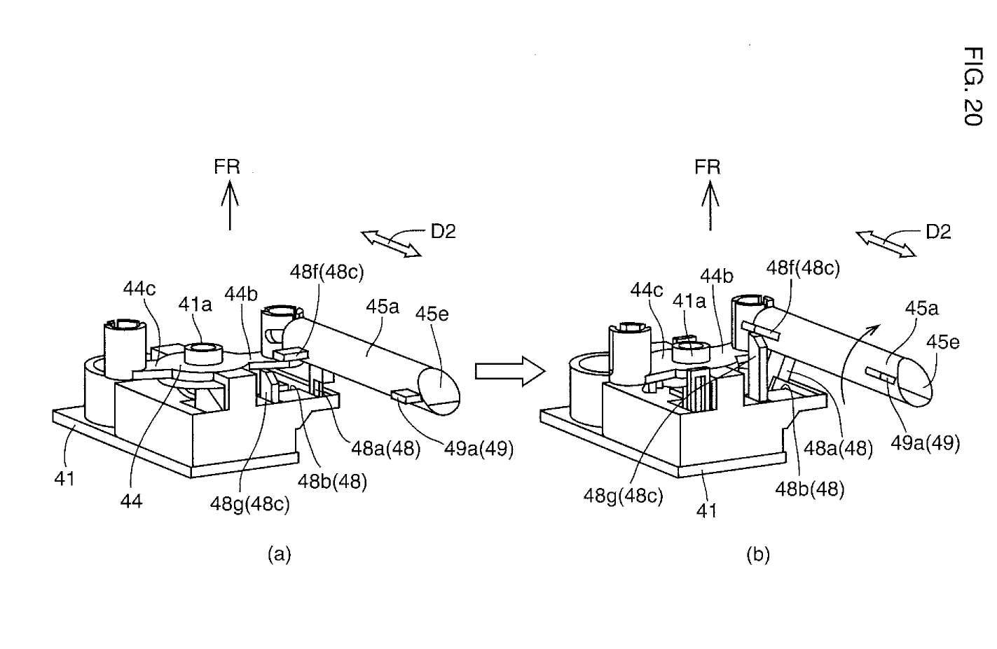

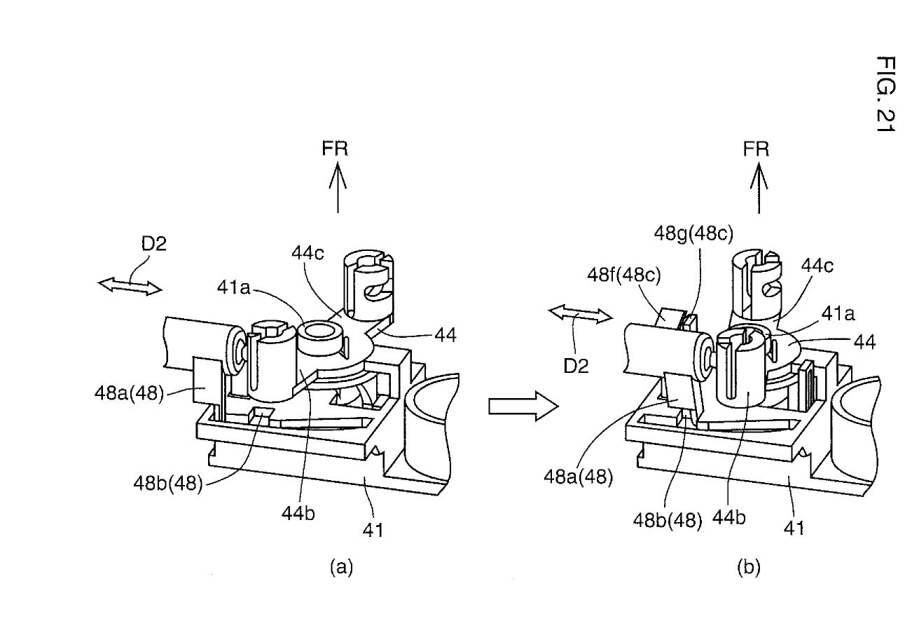

FIGS. 1-16 illustrate an interior apparatus of a vehicle according to Embodiment 1 of the present invention, and FIGS. 17-22 illustrate an interior apparatus of a vehicle according to Embodiment 2 of the present invention. However, FIG. 1 and FIG. 2 are also applicable to Embodiment 2 of the present invention. In the drawings, “FR” shows a front direction of a vehicle and “UP” shows an upper direction.

Portions common over Embodiment 1 and Embodiment 2 of the present invention are denoted with the same reference numerals over Embodiment 1 and Embodiment 2 of the present invention.
First, portions common over Embodiment 1 and Embodiment 2 of the present invention will be explained.

An interior apparatus 10 of a vehicle (hereinafter, merely “an interior apparatus”) according to any embodiment of the present invention may be, for example, a glove box disposed at an instrument panel in front of a front passenger seat of the vehicle. However, the interior apparatus 10 may be an upper box of a vehicle disposed above the glove box, a console box of a vehicle disposed between a driver seat and the front passenger seat of the vehicle, or another apparatus. In the embodiment and drawings described hereinafter, the glove box of a vehicle will be taken as an example of the interior apparatus 10.

As illustrated in FIG. 2, the interior apparatus 10 includes a fixed member 20, a movable member 30, a lock device 40 and a cushion rubber 60.

The fixed member 20 may be the instrument panel or a member fixed to the instrument panel. The fixed member 20 has a housing portion 21 open rearward (to an interior of the vehicle).

The movable member 30 opens and closes the housing portion 21. The movable member 30 can be opened and closed relative to the fixed member 20. The movable member 30 may be a door which opens and closes the housing portion 21. The movable member 30 may have a box portion (not shown) for housing some goods therein. The movable member 30 includes a rotational axis 31, an outer member 32 and an inner member 33.

The rotational axis 31 extends in a right-left direction of the vehicle at a lower end portion (and its vicinity) of the movable member 30. The movable member 30 may be coupled to the fixed member 20 so as to be rotatable about the rotational axis 31 between an open position 30a (shown in a two-dotted chain line in FIG. 2) and a closed position 30b (shown in a continuous line in FIG. 2) in an up-down direction. When the lock device 40 is unlocked, the movable member 30 can rotate (open) about the rotational axis 31 in a direction from the closed position 30b to the open position 30a by a weight of the movable member 30 itself When rotating (closing) the movable member 30 from the open position 30a to the closed position 30b, the movable member 30 is raised up manually about the rotational axis 31. When the lock device 40 is locked while the movable member 30 is at the closed position 30b, the movable member 30 can hold its closed position 30b relative to the fixed member 20. The movable member 30 can be more stroked than the closed position 30b to a position opposite the open position 30a (in a frontward direction of the vehicle) by a small amount in order to ensure that the lock device 40 is locked.

The outer member 32 and the inner member 33 are fixed to each other. The outer member 32 and the inner member 33 are fixed to each other by welding or fastening at an end of ribs 34 formed at at least one of the outer member 32 and the inner member 33 to the other of the outer member 32 and the inner member 33. An inside space 35 is provided between the outer member 32 and the inner member 33.

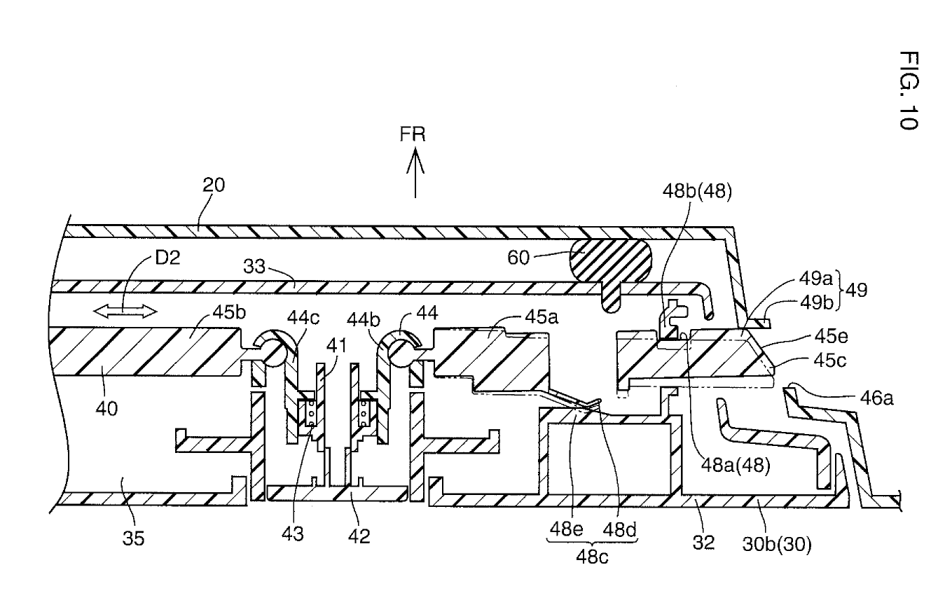

The lock device 40 is a device for locking and unlocking the movable member 30 to and from the fixed member 20 when the movable member 30 is at the closed position 30b. As illustrated in FIG. 3, the lock device 40 includes a bezel 41, a knob 42, a knob-biasing spring 43, a cam 44, a pair of rods including first and second rods 45a, 45b, a pair of lock receiving portions including first and second lock-receiving portions 46a, 46b (shown in FIG. 1), a biasing member 47, a holding structure 48 (shown in FIG. 9), a releasing structure 49 (shown in FIG. 9).

As illustrated in FIG. 8, the lock device 40 is locked when the first and second rods 45a, 45b are moved into the first and second lock-receiving portions 46a, 46b, respectively. The lock device 40 is unlocked when the first and second rods 45a, 45b are moved out from the first and second lock-receiving portions 46a, 46b, respectively.

The bezel 41 is disposed in the inside space 35 of the movable member 30 and is fixed to the movable member 30. The bezel 41 may be fixed to the outer member 32 or may be fixed to the inner member 33 of the movable member 30. The bezel 41 may be manufactured integral with the movable member 30 or may be manufactured separately from the movable member 30 and then be fixed to the movable member 30. The bezel 41 is located at a portion of the movable member 30 closer to the driver seat than a center of the movable member 30 along the direction in which the rotational axis 31 extends (i.e., in a width direction of the movable member 30, in a right-left direction of the movable member 30, and in the right-left direction of the vehicle). As illustrated in FIG. 3, the bezel 41 includes a cylindrical portion 41a having an inside surface by which the knob 42 is supported so as to be movable linearly and an outside surface by which the cam 44 is supported so as to be rotatable, and a knob slip-out preventing protrusion 41b for preventing the knob 42 from slipping-out from the bezel 41.

The knob 42 is provided in order to unlock the lock device 40. The knob 42 may be of a push-type, a pull-type or a slide-type. In the embodiment and drawings described hereinafter, the knob 42 will be of the push-type.

The knob 42 is provided at the movable member 30. The knob 42 is coupled to the bezel 41 so as to be movable reciprocally and straight in a front-rear direction of the vehicle when the movable member 30 is at the closed position 30b. The knob 42 is assembled to the bezel 41 from a rear side of the bezel in the front-rear direction of the vehicle when the movable member 30 is at the closed position 30b. The knob 42 includes a knob cylindrical portion 42a, a knob stopper 42b and a cam pushing protrusion 42c.

The knob cylindrical portion 42a extends at a predetermined amount toward the bezel 41 (i.e., in a frontward direction of the vehicle when the movable member 30 is at the closed position). The knob cylindrical portion 42a is disposed inside the cylindrical portion 41a of the bezel 41. The knob cylindrical portion 42a is supported by the cylindrical portion 41a of the bezel 41 so as to be movable reciprocally and straight in the front-rear direction of the vehicle when the movable member 30 is at the closed position 30b. Therefore, the knob 42 is coupled to the bezel 41 so as to be movable reciprocally and straight.

The knob stopper 42b is provided in order to prevent the knob 42 from slipping-out from the bezel 41 by a biasing force of the knob-biasing spring 43. The number of the knob stoppers 42b and the number of the knob slip-out preventing protrusions 41b of the bezel 41 are equal to each other. At least one knob stopper 42b is provided and at least one knob slip-out preventing protrusion 41b is provided. In the drawings, two knob stoppers 42b are provided and two knob slip-out preventing protrusions 41b are provided. When the knob 42 is moved by the knob-biasing spring 43 in a direction in which the knob 42 is slipped-out from the bezel 41 (in the rearward direction of the vehicle when the movable member 30 is at the closed position 30b), the knob stopper 42b is brought into contact with (is engaged with) the knob slip-out preventing protrusion 41b of the bezel 41 whereby the knob 42 is prevented from moving further in the direction in which the knob 42 is slipped-out from the bezel 41 (in the rearward direction of the vehicle).

The cam pushing protrusion 42c is provided in order to cause the cam 44 to rotate about a rotational axis P of the cam 44 when the push-type knob 42 is operated. The cam 44 is rotated by the cam pushing protrusion 42c in a direction in which the first and second rods 45a, 45b are moved out (withdrawn) from the first and second lock-receiving portions 46a, 46b when the push-type knob 42 is operated. The cam pushing protrusion 42c is provided so as to protrude toward the cam 44 (i.e., toward the bezel 41, in the frontward direction of the vehicle when the movable member 30 is at the closed position 30b). When the push-type knob 42 is operated, the cam pushing protrusion 42c is brought into contact with an inclined portion 44d, which will be described later, of the cam 44 whereby the cam 44 is rotated.

The knob 42 is always biased by the knob-biasing spring 43 in the direction in which the knob 42 is slipped-out from the bezel 41 (in the rearward direction of the vehicle when the movable member 30 is at the closed position 30b) relative to the bezel 41. The knob-biasing spring 43 is constructed from, for example, a coil spring one end of which contacts the bezel 41 and the other end of which contacts the knob 42.

The cam 44 is provided at the movable member 30. The cam 44 is disposed in the inside space 35 of the movable member 30. The cam 44 is coupled to the bezel 41 so as to be rotatable about the rotational axis P. The cam 44 is assembled to the bezel 41 from a front side of the bezel in the front-rear direction of the vehicle when the movable member 30 is at the closed position 30b. The cam 44 includes a rotatable hub portion 44a, a first cam arm 44b extending from the rotatable hub portion 44a toward one direction, a second cam arm 44c extending from the rotatable hub portion 44a toward the other direction, and the inclined portion 44d.

The cylindrical portion 41a of the bezel 41 is inserted into a hole 44e formed at the rotatable hub portion 44a whereby the cam 44 is coupled to the bezel 41 so as to be rotatable at the rotatable hub portion 44a. The first rod 45a which is one of the pair of rods 45a, 45b is connected to an arm tip (and its vicinity) of the first cam arm 44b and the second rod 45b which is the other of the pair of rods 45a, 45b is connected to an arm tip (and its vicinity) of the second cam arm 44c.

Since (i) the cam 44 is coupled to the bezel 41 so as to be rotatable at the rotatable hub portion 44a, (ii) the first rod 45a is connected to the first cam arm 44b and (iii) the second rod 45b is connected to the second cam arm 44c, the first and second rods 45a, 45b are movable synchronously in motion in opposite directions to each other by being rotated the cam 44.

The inclined portion 44d is provided in order to convert a linear motion of the knob 42 relative to the bezel 41 to rotation of the cam 44 relative to the bezel 41. The inclined portion 44d is formed at a portion of the cam 44 except the rotational axis P. The inclined portion 44d is provided so as to protrude toward the knob 42 (i.e., toward the bezel 41, in the rearward direction of the vehicle when the movable member 30 is at the closed position 30b). An inclined surface is formed at a top surface (at a knob 42-side surface) of the inclined portion 44d.

As illustrated in FIG. 8, the first and second rods 45a, 45b of the pair of rods are provided at the movable member 30. Each of the first and second rods 45a, 45b extends in a rod-extending direction D2. The rod-extending direction D2 is a direction in which the rotational axis 31 of the movable member 30 extends. Each of the first and second rods 45a, 45b may be straight or may be bent or curved at at least one bent portion or curved portion. When the movable member 30 is at the closed position 30b, the end portion 45c of the first rod 45a opposite the second rod 45b is moved into and out from the first lock-receiving portion 46a which is one of the pair of lock-receiving portions 46a, 46b, and the end portion 45d of the second rod 45b opposite the first rod 45a is moved into and out from the second lock-receiving portion 46b which is the other of the pair of lock-receiving portions 46a, 46b. Moving of the first rod 45a into the first lock-receiving portion 46a and moving of the second rod 45b into the second lock-receiving portion 46b are conducted simultaneously. Moving of the first rod 45a out from the first lock-receiving portion 46a and moving of the second rod 45b out from the second lock-receiving portion 46b are conducted simultaneously. An inclined surface 45e is formed at each of the end portion 45c of the first rod 45a and the end portion 45d of the second rod 45b. The inclined surface 45e is inclined in the direction in which the movable member 30 is moved from the open position 30a to the closed position 30b and in a direction in which a length of each of the rods 45a, 45b is shorten. An entirety of the first rod 45a except the end portion 45c and an entirety of the second rod 45b except the end portion 45d are located in the inside space 35 of the movable member 30.

The first and second lock-receiving portions 46a, 46b of the lock-receiving portions are provided at the fixed member 20. The first and second lock-receiving portions 46a, 46b are located at opposite end portions of the movable member 30 along the direction in which the rotational axis 31 extends. The first and second lock-receiving portions 46a, 46b are provided at a wall portion of the fixed member 20 opposing the movable member 30 along the direction in which the rotational axis 31 extends or at a bush fixed to the wall portion.

The first and second rods 45a, 45b are biased by the biasing member 47 relative to the movable member 30 in the rod-extending direction D2 and in a direction in which the first and second rods 45a, 45b are moved into the first and second lock-receiving portions 46a, 46b, respectively. As illustrated in FIG. 3, the first and second rods 45a, 45b are biased by the biasing member 47 by, for example, rotatably biasing the cam 44 relative to the bezel 41. The biasing member 47 is constructed from, for example, a torsion spring one end of which contacts the bezel 41 and the other end of which contacts the cam 44. However, the biasing member 47 may be constructed from a coil spring one end of which contacts the movable member 30 and the other end of which contacts the one of the first and second rods 45a, 45b thereby biasing the first and second rods 45a, 45b relative to the movable member 30.

The holding structure 48 is a structure for holding a state that the ends of the first and second rods 45a, 45b are withdrawn from the first and second lock-receiving portions 46a, 46b relative to the movable member 30, when the push-type knob 42 has been operated and the first and second rods 45a, 45b have been pulled against the biasing force of the biasing member 47 whereby the ends of the first and second rods 45a, 45b have been withdrawn from the first and second lock-receiving portions 46a, 46b, respectively.

As illustrated in FIGS. 8 and 9, the holding structure 48 includes an engagement portion 48a, an engagement-receiving portion 48b and a movement structure 48c. The engagement portion 48a is provided at at least one of the first and second rods 45a, 45b. The engagement-receiving portion 48b is provided at the movable member 30 (including a member fixed to the movable member 30). The engagement portion 48a is capable of engaging with and disengaging from the engagement-receiving portion 48b. In the embodiment described hereinafter, the engagement portion 48a will be provided at the first rod 45a only.

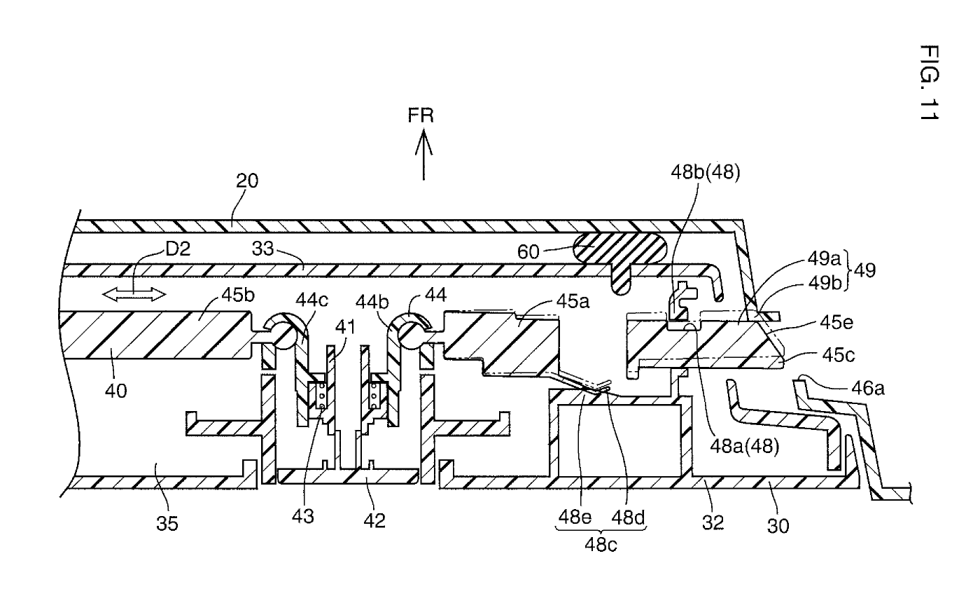

The engagement portion 48a may be formed integral with the first rod 45a or may be manufactured separately from the first rod 45a and then be fixed to the first rod 45a. The engagement-receiving portion 48b may be formed integral with the movable member 30 or may be manufactured separately from the movable member 30 and then be fixed to the movable member 30. As illustrated in FIG. 10, the movement structure 48c is a structure for moving the first rod 45a at which the engagement portion 48a is provided in a direction different from (perpendicular to) the rod-extending direction D2 and in a direction in which the engagement portion 48a and the engagement-receiving portion 48b are brought into engagement with each other when the push-type knob 42 is being operated and the first and second rods 45a, 45b are being withdrawn from the first and second lock-receiving portions 46a, 46b, respectively.

Holding of the first and second rods 45a, 45b by the holding structure 48 is conducted by engaging the engagement portion 48a with the engagement-receiving portion 48b. Holding of the first and second rods 45a, 45b by the holding structure 48 is released by releasing the engagement of the engagement portion 48a with the engagement-receiving portion 48b.

The releasing structure 49 is a structure for releasing the holding state by the holding structure 48, by moving the first rod 45a in a direction in which engagement of the engagement portion 48a with the engagement-receiving portion 48b is released, when the movable member 30 is being moved from the open position 30a to the closed position 30b. The direction in which the first rod 45a is moved by the releasing structure 49 and the direction in which the first rod 45a is moved by the movement structure 48c of the holding structure 48 are opposite to each other.

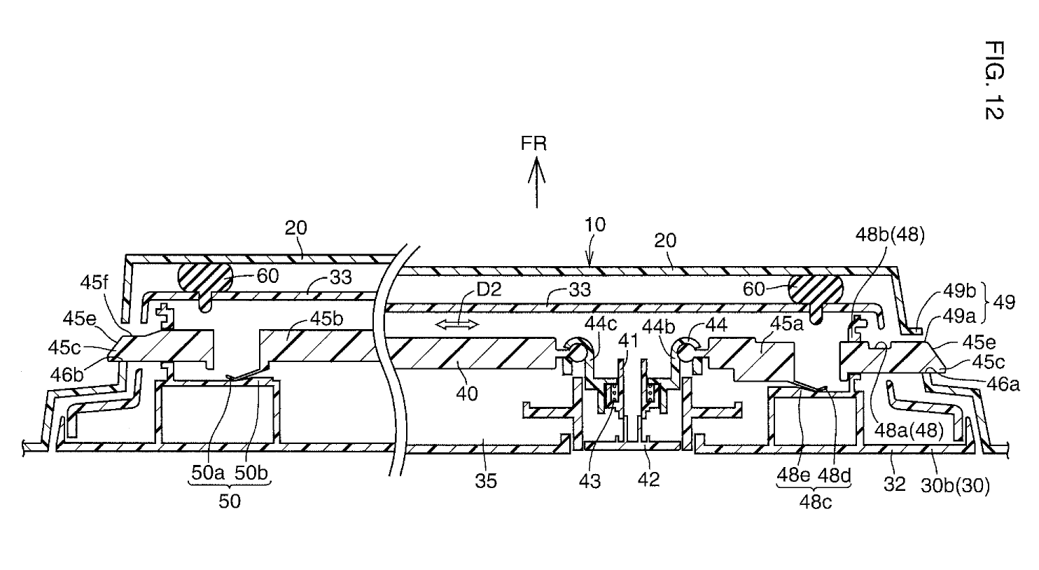

The releasing structure 49 includes a first releasing structure element 49a provided at the first rod 45a and a second releasing structure element 49b provided at the fixed member 20 (which may include a member fixed to the fixed member 20). The first releasing structure element 49a may be formed integral with the first rod 45a or may be manufactured separately from the first rod 45a and then be fixed to the first rod 45a. The second releasing structure element 49b may be formed integral with the fixed member 20 or may be manufactured separately from the fixed member 20 and then be fixed to the fixed member 20. As illustrated in FIG. 11, the first rod 45a is moved by the releasing structure 49 in the direction in which engagement of the engagement portion 48a with the engagement-receiving portion 48b is released, by contacting the first releasing structure element 49a with the second releasing structure element 49b, when the movable member 30 is being moved from the open position 30a to the closed position 30b.

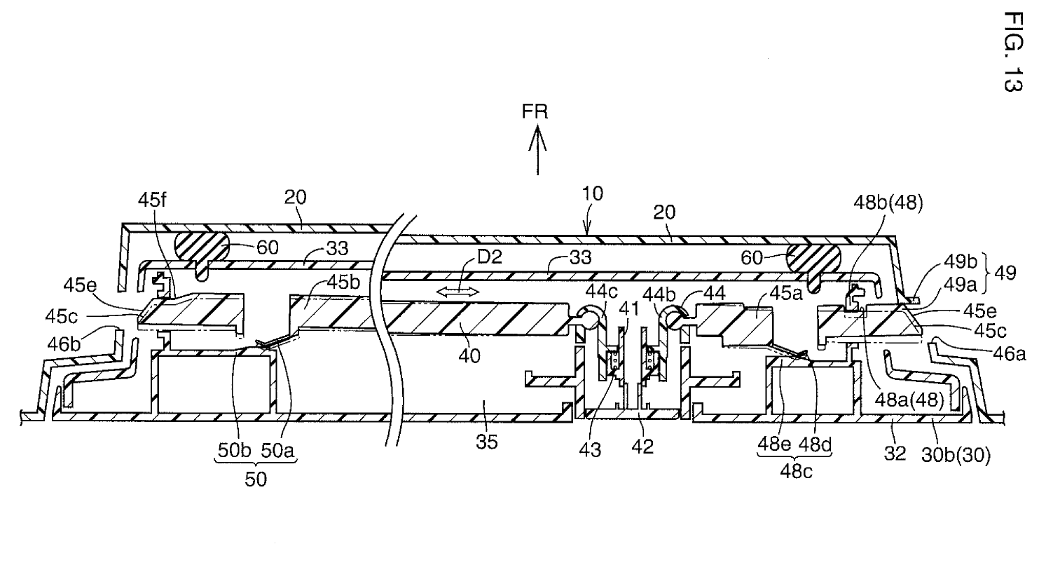

As illustrated in FIGS. 12 and 13, the lock device 40 may include a displacement structure 50. As illustrated in FIG. 12, the displacement structure 50 is provided in a case where the engagement portion 48a is provided only at one (the first rod 45a) of the pair of rods 45a, 45b.

As illustrated in FIG. 13, the displacement structure 50 is a structure for displacing the second rod 45b at which the engagement portion is not provided in a direction different from (perpendicular to) the rod-extending direction D2 relative to the movable member 30 (including a member fixed to the movable member 30), while the ends of the first and second rods 45a, 45b have been withdrawn from the first and second lock-receiving portions 46a, 46b against the biasing force of the biasing member 47. The second rod 45b is displaced by the displacement structure 50 in the direction in which the movable member 30 is moved from the open position 30a to the closed position 30b relative to the fixed member 20. The second rod 45b is displaced by the displacement structure 50 relative to the movable member 30 in the frontward direction of the vehicle when the movable member 30 is at the closed position 30b. The second rod 45b is displaced by the displacement structure 50 relative to the movable member 30 in the frontward direction of the vehicle when the movable member 30 is at the closed position 30b and when the ends of the first and second rods 45a, 45b are being withdrawn from the first and second lock-receiving portions 46a, 46b against the biasing force of the biasing member 47.

The second rod 45b is not (including substantially not) displaceable relative to the movable member 30 in the direction in which the second rod 45b is displaced by the displacement structure 50, when the ends of the first and second rods 45a, 45b are not withdrawn from the first and second lock-receiving portions 46a, 46b. A recess portion 45f is formed at the second rod 45b such that the second rod 45b can be displaced by the displacement structure 50 relative to the movable member 30 when the ends of the first and second rods 45a, 45b are withdrawn from the first and second lock-receiving portions 46a, 46b. The recess portion 45f is formed at the second rod 45b so as to be recessed in the rearward direction of the vehicle when the movable member 30 is at the closed position 30b.

The displacement structure 50 includes a first displacement structure element 50a elastically deformably provided at one of the second rod 45b and the movable member 30 and a second displacement structure element 50b provided at the other of the second rod 45b and the movable member 30. By causing the first displacement structure element 50a to slide onto the second displacement structure element 50b, the second rod 45b is displaced by the displacement structure 50 relative to the movable member 30. The first displacement structure element 50a is located on the second displacement structure element 50b while the ends of the first and second rods 45a, 45b are withdrawn from the first and second lock-receiving portions 46a, 46b against the biasing force of the biasing member 47.

The first displacement structure element 50a is constructed from, for example, a leaf spring formed integral with one of the second rod 45b and the movable member 30 and is elastically deformable by using elasticity of resin. The second displacement structure element 50b is constructed from, for example, a rib formed integral with the other of the second rod 45b and the movable member 30.

The cushion rubber 60 is provided in order to suppress the movable member 30 from rattling relative to the fixed member 20 when the movable member 30 is at the closed position 30b and the vehicle runs. The cushion rubber 60 may be fixed to the fixed member 20 or the movable member 30. When the movable member 30 is at the closed position 30b, the cushion rubber 60 is compressed and deformed by the fixed member 20 and the movable member 30 in the front-rear direction of the vehicle. When the movable member 30 is at the open position 30a, the cushion rubber 60 is neither compressed nor deformed by the fixed member 20 and the movable member 30 in the front-rear direction of the vehicle.

Next, operation of the above-described structures common to Embodiment 1 and Embodiment 2 of the present invention will be explained.

(i) When the movable member 30 is at the closed position 30b:
As illustrated in FIG. 12, the ends of the first and second rods 45a, 45b are located inside the first and second lock-receiving portions 46a, 46b, respectively. Therefore, the lock device 40 is locked.
The second rod 45b is not displaced by the displacement structure 50 relative to the movable member 30.

(ii) When the knob 42 is operated in the frontward direction of the vehicle in order to unlock the lock device 40:

The cam pushing protrusion 42c of the knob 42 is brought into slidably contact with the inclined portion 44d of the cam 44. Therefore, the cam 44 is rotated against the biasing force of the biasing member 47, and the first and second rods 45a, 45b are withdrawn from the first and second lock-receiving portions 46a, 46b against the biasing force of the biasing member 47. As a result, as illustrated in FIG. 13, the lock device is unlocked.
The second rod 45b is displaced by the displacement structure 50 relative to the movable member 30 in the frontward direction of the vehicle when the movable member 30 is at the closed position 30b.

(iii) When the push-operating force of the push-type knob 42 is released after the lock device 40 is unlocked:

The knob 42 is moved in the rearward direction of the vehicle relative to the bezel 41 by the biasing force of the knob-biasing spring 43 and returns to a state before the knob 42 is operated. A state that the ends of the first and second rods 45a, 45b are withdrawn from the first and second lock-receiving portions 46a, 46b is held by the holding structure 48.
The second rod 45b is displaced by the displacement structure 50 relative to the movable member 30.
The movable member 30 rotates (opens) in the direction from the closed position 30b to the open position 30a by the weight of the movable member 30 itself.

(iv) When the movable member is at the open position 30a:

The state that the ends of the first and second rods 45a, 45b are withdrawn from the first and second lock-receiving portions 46a, 46b is held by the holding structure 48.
The second rod 45b is displaced by the displacement structure 50 relative to the movable member 30.

(v) When the movable member 30 is moved from the open position 30a to the closed position 30b:

When the movable member 30 is moved from the open position 30a toward the closed position 30b and arrives at a position close to the closed position 30b, the first and second releasing structure elements 49a, 49b of the releasing structure 49 begin to be brought into contact with each other. As illustrated in FIG. 11, when the movable member 30 is further moved to the closed position 30b, the first releasing structure element 49a is pushed by the second releasing structure element 49b. Since the first releasing structure element 49a is pushed by the second releasing structure element 49b, the first rod 45a is moved in the direction in which engagement of the engagement portion 48a with the engagement-receiving portion 48b is released (in the direction in which the holding by the holding structure 48 is released).
When the holding by the holding structure 48 is released by the releasing structure 49, the first and second rods 45a, 45b are moved into the first and second lock-receiving portions 46a, 46b relative to the movable member 30 by the biasing force of the biasing member 47 whereby the lock device 40 is locked. The second rod 45b returns to the state before the second rod 45b is displaced by the displacement structure 50 relative to the movable member 30.

Next, operation and technical advantages common to Embodiment 1 and Embodiment 2 of the present invention will be explained.

(A) When the push-type knob 42 is operated and the first and second rods 45a, 45b are pulled against the biasing force of the biasing member 47, the ends of the first and second rods 45a, 45b are withdrawn from the first and second lock-receiving portions 46a, 46b, respectively. Since the lock device 40 includes the holding structure 48 for holding the state that the ends of the first and second rods 45a, 45b have been withdrawn from the first and second lock-receiving portions 46a, 46b, the following technical advantages can be obtained:
(A1) When the movable member 30 is moved from the open position 30a to the closed position 30b (when the movable member 30 is closed), it is possible to prevent the first and second rods 45a, 45b from contacting the fixed member 20 thereby being pushed by the fixed member 20. Therefore, a force which will occur if the first and second rods 45a, 45b are brought into contact with the fixed member 20 and are pushed by the fixed member 20 does not occur. As a result, when the movable member 30 is closed, it is possible to improve an operating feeling compared with that of the conventional interior apparatus of a vehicle.
(A2) Even if the pushing operation is released after the lock device 40 is unlocked by operating the push-type knob 42, it is possible to prevent the first and second rods 45a, 45b from being moved into the first and second lock-receiving portions 46a, 46b (the lock device 40 from being locked) by the biasing force of the biasing member 47.
Therefore, even in a case where the push-type knob 42 is provided at the movable member 30, it is possible to cause the movable member 30 to surely be moved from the closed position 30b to the open position 30a by the weight of the movable member 30 itself.

(B) The holding structure 48 includes the movement structure 48c for moving the first rod 45a in the direction different from the extending direction of the first rod 45a and in the direction in which the engagement portion 48a and the engagement-receiving portion 48b are brought into engagement with each other when the push-type knob 42 is being operated and the first and second rods 45a, 45b are being withdrawn from the first and second lock-receiving portions 46a, 46b, respectively. Thus, the following technical advantages can be obtained:

By only withdrawing the first and second rods 45a, 45b from the first and second lock-receiving portions 46a, 46b (i.e., by only operating the push-type knob 42), the engagement portion 48a and the engagement-receiving portion 48b can be brought into engagement with each other. Therefore, an operability of the interior apparatus of a vehicle 10 can be improved, compared with a case where another operation (i) which is different from the operation of withdrawing the first and second rods 45a, 45b from the first and second lock-receiving portions 46a, 46b (the operation of the push-type knob 42) and (ii) which causes the engagement portion 48a and the engagement-receiving portion 48b to engage with each other, is required.

(C) The lock device 40 includes the releasing structure 49 for releasing the holding state by the holding structure 48, by moving the first rod 45a in the direction in which engagement of the engagement portion 48a with the engagement-receiving portion 48b is released, when the movable member 30 is being moved from the open position 30a to the closed position 30b. Thus, the following operation and technical advantages can be obtained:

By only causing the movable member 30 to move from the open position 30a to the closed position 30b, the holding by the holding structure 48 can be released. Therefore, an operability of the interior apparatus of a vehicle 10 can be improved, compared with a case where another operation which is different from the operation for closing the movable member 30 and which causes to release the holding by the holding structure 48 is required.

(D) The releasing structure 49 includes the first releasing structure element 49a provided at the first rod 45a and the second releasing structure element 49b provided at the fixed member 20. The second releasing structure element 49b is brought into contact with the first releasing structure element 49a when the movable member 30 is being moved from the open position 30a to the closed position 30b. Thus, the following technical advantages can be obtained:

By causing the first releasing structure element 49a to be brought into contact with the second releasing structure element 49b, the first rod 45a can be moved in the direction in which engagement of the engagement portion 48a with the engagement-receiving portion 48b is released.

(E) The lock device 40 includes the displacement structure 50 for displacing the second rod 45b in the direction different from the rod-extending direction D2 relative to the movable member 30, while the ends of the first and second rods 45a, 45b are withdrawn from the first and second lock-receiving portions 46a, 46b against the biasing force of the biasing member 47. Thus, the following technical advantages can be obtained:

When the movable member 30 is moved from the open position 30a to the closed position 30b and arrives at the closed position 30b, even in a case where the second rod 45b is displaced in the rearward direction of the vehicle relative to the lock-receiving portion 46b due to a torsion of the movable member 30, an amount of the displacement can be decreased by an amount that the second rod 45b is displaced by the displacement structure 50 in the frontward direction of the vehicle. Therefore, the second rod 45b can be surely moved into the lock-receiving portion 46b, compared with a case where the lock device 40 does not include the displacement structure 50.

(F) Since the inclined surface 45e is formed at each of the end portion 45c of the first rod 45a and the end portion 45d of the second rod 45b, the following technical advantages can be obtained:

Even in a case where the holding of the first and second rods 45a, 45b by the holding structure 48 is released not by the releasing structure 49 but by, for example, touching on the first rod 45a by the user of the interior apparatus 10, the inclined surface 45e is brought into contact with the fixed member 20 when the movable member 30 is moved from the open position 30a to the closed position 30b, whereby the ends of the first and second rods 45a, 45b can be withdrawn from the first and second lock-receiving portions 46a, 46b. Therefore, the movable member 30 can surely return to the closed position 30b.

(G) The knob 42 is coupled to the bezel 41 from the rear side of the bezel in the front-rear direction of the vehicle and the cam 44 is coupled to the bezel 41 from the front side of the bezel in the front-rear direction of the vehicle when the movable member 30 is at the closed position 30b. Thus, the following technical advantages can be obtained:

An assembling direction of the knob 42 and the cam 44 to the bezel 41 is one direction of the front-rear direction of the vehicle. Therefore, man-hour of assembling the knob 42 and the cam 44 to the bezel 41 can be decreased. In a case where the knob 42 and the cam 44 are assembled to the bezel 41 by using an equipment, since a complex movement is not required, it is possible to relatively easily assemble the knob 42 and the cam 44 to the bezel 41 by using the equipment and thus, to reduce an equipment cost.

(H) Since (i) the knob 42 is supported by the bezel 41 and (ii) the bezel 41 is located at a portion of the movable member 30 closer to the driver seat than the center of the movable member 30 along the direction in which the rotational axis 31 extends, the following technical advantages can be obtained:

The knob 42 also is located at the portion of the movable member 30 closer to the driver seat than the center of the movable member 30 along the direction in which the rotational axis 31 extends. Therefore, an operability of the knob 42 by a driver from the driver seat is good.

(I) Since the knob 42 is of the push type, the following technical advantages can be obtained:

It is easy to operate the knob 42 compared with a case where the knob 42 is of a rotation type. Unlike a rotation-type knob provided at the movable member 30, a recess used for inserting a finger is not required to be provided in the movable member 30 at a rear of the knob 42. As a result, an appearance of the movable member 30 is good.

Next, portions unique to each embodiment of the present invention will be explained.

### Embodiment 1 (FIGS. 1-16)

In Embodiment 1 of the present invention, the holding structure 48 is constructed as follows: As illustrated in FIG. 9, the movement structure 48c of the holding structure 48 includes a first movement structure element 48d elastically deformably provided at one of the first rod 45a and the movable member 30 and a second movement structure element 48e provided at the other of the first rod 45a and the movable member 30, where the engagement portion 48a is provided at the first rod 45a and the engagement-receiving portion 48b is provided at the movable member 30. In Embodiment 1 of the present invention, the first movement structure element 48d will be elastically deformably provided at the first rod 45a at which the engagement portion 48a is provided.

The first movement structure element 48d is constructed from, for example, a leaf spring formed integral with the first rod 45a and is elastically deformable by using elasticity of resin. The second movement structure element 48e is constructed from, for example, a rib formed integral with the movable member 30.

When the first and second rods 45a, 45b are being withdrawn from the first and second lock-receiving portions 46a, 46b, respectively, by causing the first movement structure element 48d to slide onto the second movement structure element 48e, the first rod 45a is moved by the movement structure 48c in the direction different from (perpendicular to) the rod-extending direction D2 and in the direction in which the engagement portion 48a and the engagement-receiving portion 48b are brought into engagement with each other.

In Embodiment 1 of the present invention, the releasing structure 49 is constructed as follows:

The first releasing structure element 49a of the releasing structure 49 comprises a portion (a contact surface provided at the first rod 45a) of the first rod 45a. The second releasing structure element 49b of the releasing structure 49 comprises a portion of the fixed member 20 (i.e., a protrusion provided at the fixed member 20).

Next, operation and technical advantages unique to Embodiment 1 of the present invention will be explained.

(i) Since the movement structure 48c of the holding structure 48 includes the first and second movement structure elements 48d, 48e, and (ii) since by causing the first movement structure element 48d to slide onto the second movement structure element 48e, the first rod 45a is moved in the direction different from the rod-extending direction D2 and in the direction in which the engagement portion 48a is engaged with the engagement-receiving portion 48b, the following technical advantages can be obtained:
The engagement portion 48a and the engagement-receiving portion 48b can be surely engaged with each other by a relatively simple structure.

### Alteration of Embodiment 1

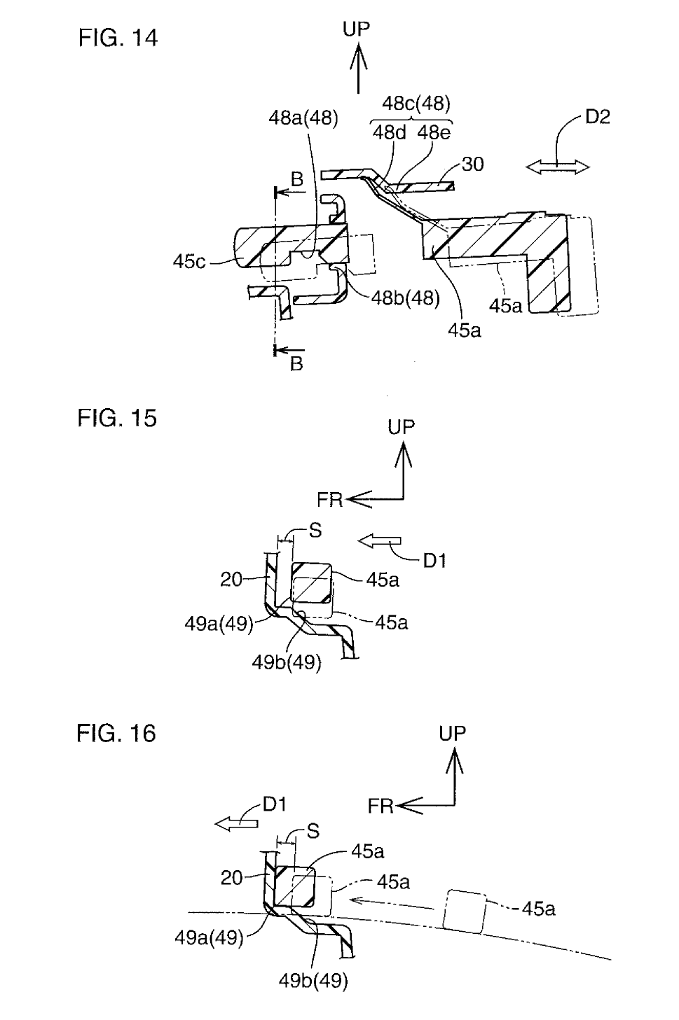

FIGS. 14-16 illustrate an alteration of Embodiment 1 of the present invention. In the alteration of Embodiment 1 of the present invention, the first rod 45a has been moved by the movement structure 48c of the holding structure 48 in a direction (an up-down direction) perpendicular to direction D1 (the frontward direction of the vehicle). Direction D1 is a direction in which the movable member 30 is moved relative to the fixed member 20, when the movable member 30 is moved from the open position 30a to the closed position 30b and just (or nearly) arrives at the closed position 30b. The first rod 45a has been moved by the releasing structure 49 in the direction (the up-down direction) perpendicular to the direction D1, whereby the holding of the holding structure 48 has been released by the releasing structure 49. A space S exists between the fixed member 20 and the first rod 45a when the holding by the holding structure 48 has been released by the releasing structure 49. In the embodiment shown, the first rod 45a is moved in a down direction by the movement structure 48c of the holding structure 48 and is moved in an up direction by the releasing structure 49.

Operation and technical advantages according to Alteration of Embodiment 1 of the present invention will now be explained.

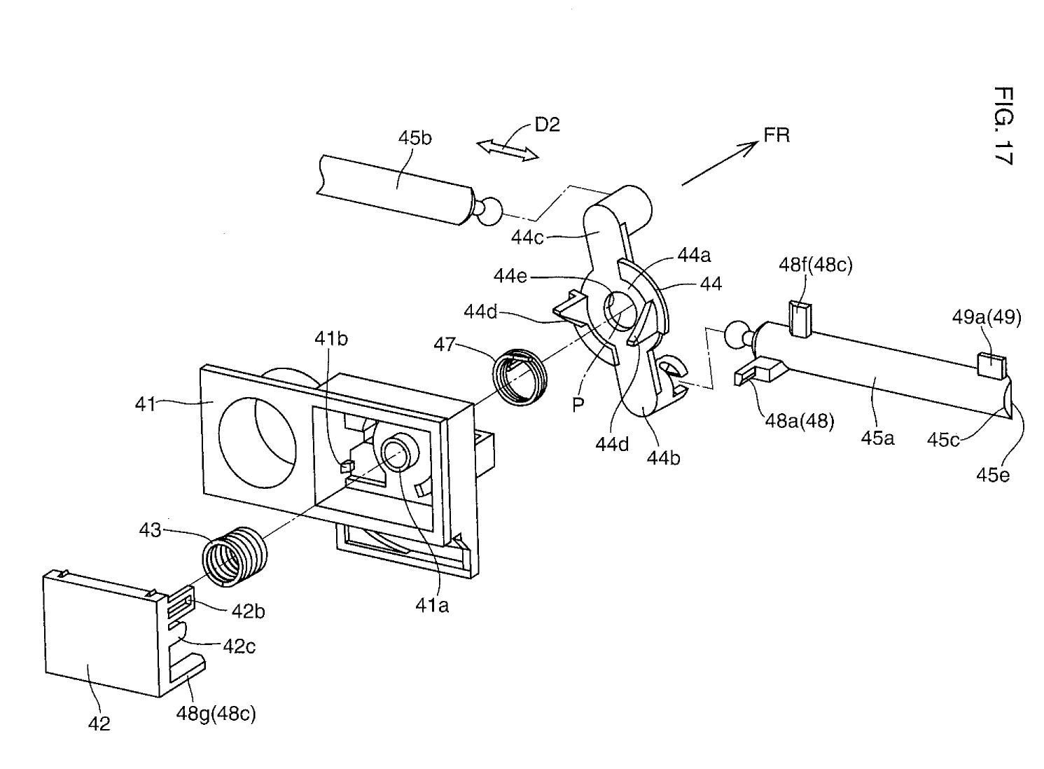

(i) The first rod 45a has been moved by the movement structure 48c of the holding structure 48 in the direction perpendicular to direction D1. (ii) The first rod 45a has been moved by the releasing structure 49 in the direction perpendicular to the direction D1 whereby the holding of the holding structure 48 has been released by the releasing structure 49. (iii) The space S exists between the fixed member 20 and the first rod 45a when the holding by the holding structure 48 has been released by the releasing structure 49. Thus, the following technical advantages can be obtained:
As illustrated in FIG. 16, the first rod 45a can be moved in direction D1 in the space S relative to the fixed member 20 after the holding of the holding structure 48 has been released by the releasing structure 49. Therefore, even in a case where the movable member 30 is wildly (rapidly) moved from the open position 30a to the closed position 30b relative to the fixed member 20 after the holding of the holding structure 48 has been released by the releasing structure 49, the first rod 45 is prevented from contacting the fixed member 20 and thus, the movement of the movable member 30 from the open position 30a to the closed position 30b is not obstructed. Therefore, even in the case where the movable member 30 is wildly (rapidly) moved from the open position 30a to the closed position 30b relative to the fixed member 20, the movable member 30 is moved surely to the closed position 30b and the lock device 40 is surely locked.

### Embodiment 2 (FIGS. 17-22)

In Embodiment 2 of the present invention, the holding structure 48 is constructed as follows:
As illustrated in FIG. 21, the engagement-receiving portion 48b of the holding structure 48 is provided at the bezel 41 fixed to the fixed member 20. As illustrated in FIG. 20, the movement structure 48c of the holding structure 48 includes a first rotational structure element 48f provided at the first rod 45a and a second rotational structure element 48g provided at the push-type knob 42.

The first rotational structure element 48f is provided so as to protrude from an outside surface of the first rod 45a outwardly in a radial direction of the first rod 45a. The first rotational structure element 48f may be formed integral with the first rod 45a or may be manufactured separately from the first rod 45a and then be fixed to the first rod 45a. The second rotational structure element 48g is provided so as to protrude from the knob 42 toward the bezel 41 (i.e., frontward of the vehicle when the movable member 30 is at the closed position 30b). The second rotational structure element 48g may be formed integral with the knob 42 or may be manufactured separately from the knob 42 and then be fixed to the knob 42.

When the push-type knob 42 is being operated and the first and second rods 45a, 45b are being withdrawn from the first and second lock-receiving portions 46a, 46b, respectively, and when the first rotational structure element 48f is pushed by the second rotational structure element 48g at the operating force added on the push-type knob 42, the first rod 45a is rotated by the movement structure 48c about an axis of the first rod 45a in the direction in which the engagement portion 48a and the engagement-receiving portion 48b are engaged with each other.

In Embodiment 2 of the present invention, the releasing structure 49 is constructed as follows:

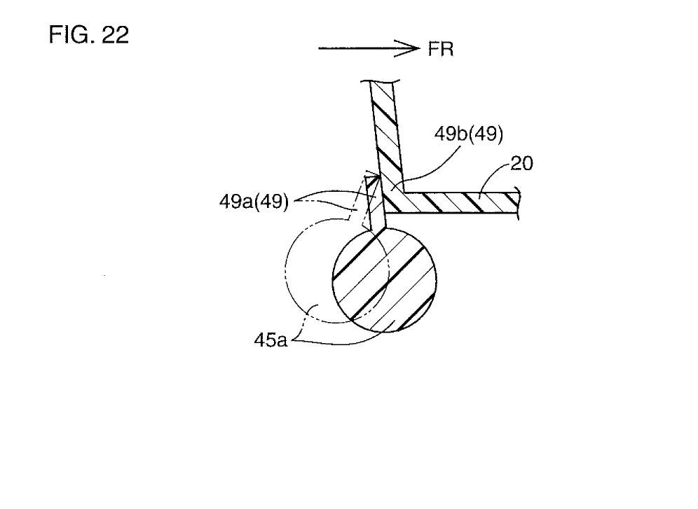

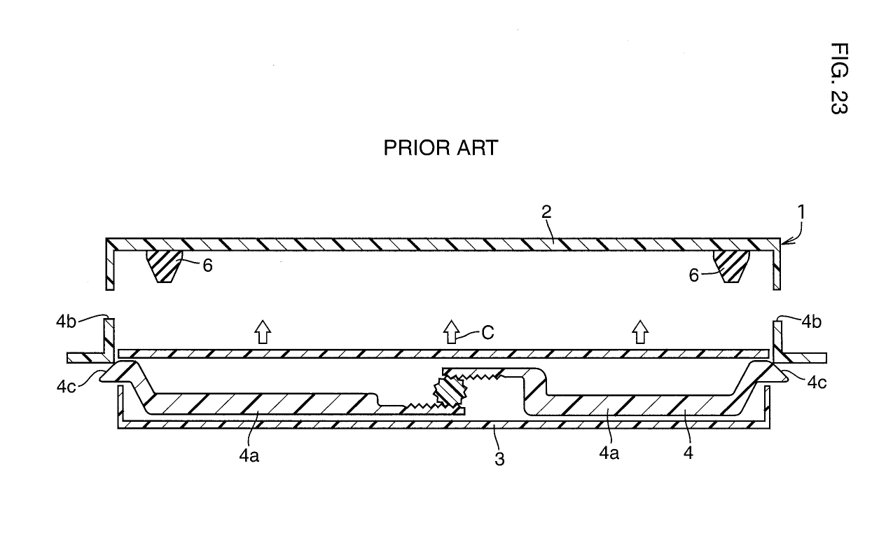

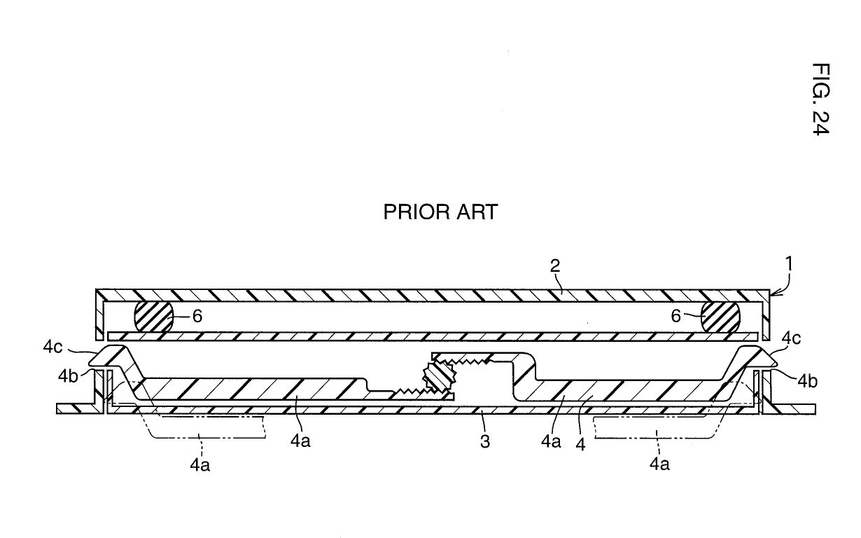

As illustrated in FIG. 20, the first releasing structure element 49a of the releasing structure 49 comprises a radial protrusion protruding from the first rod 45a outwardly in the radial direction of the first rod 45a. As illustrated in FIG. 22, the second releasing structure element 49b of the releasing structure 49 comprises a portion of the fixed member 20 (i.e., a protrusion provided at the fixed member 20).

Next, operation and technical advantages unique to Embodiment 2 of the present invention will be explained.

Since the movement structure 48c of the holding structure 48 includes the first and second rotational structure elements 48f, 48g, and since the first rod 45a is rotated about the axis of the first rod 45a by the operating force added on the push-type knob 42 in the direction in which the engagement portion 48a and the engagement-receiving portion 48b are engaged with each other, the following technical advantages can be obtained:
By only operating the push-type knob 42, the engagement portion 48a and the engagement-receiving portion 48b can be surely engaged with each other by a relatively simple structure.

### EXPLANATION OF REFERENCE NUMERALS

10 interior apparatus of a vehicle
20 fixed member
30 movable member
31 rotational axis of the movable member
32 outer member
33 inner member
40 lock device
41 bezel
42 knob
43 knob-biasing spring
44 cam
45a first rod
45b second rod
46a first lock-receiving portion
46b second lock-receiving portion
47 biasing member
48 holding structure
48a engagement portion
48b engagement-receiving portion
48c movement structure
48d first movement structure element
48e second movement structure element
48f first rotational structure element
48g second rotational structure element
49 releasing structure
49a first releasing structure element
49b second releasing structure element
50 displacement structure
50a first displacement structure element
50b second displacement structure element
60 cushion rubber
D1 direction in which the movable member is moved
D2 rod-extending direction
S space

1. An interior apparatus of a vehicle comprising:
a fixed member;
a movable member movable relative to the fixed member between an open position and a closed position; and
a lock device for locking and unlocking the movable member to and from the fixed member when the movable member is at the closed position,
wherein the lock device includes:
a pair of rods including first and second rods, provided at the movable member and extending in a rod-extending direction;
a synchronizing structure for synchronizing the first and second rods such that the first and second rods are moved in opposite directions to each other in the rod-extending direction;
a pair of lock-receiving portions including first and second lock-receiving portions, provided at the fixed member such that ends of the first and second rods are moved into and out from the first and second lock-receiving portions, respectively;
a biasing member for biasing the first and second rods in opposite directions in which the ends of the first and second rods are moved into the first and second lock-receiving portions, respectively; and
a holding structure for holding a state that the ends of the first and second rods are withdrawn from the first and second lock-receiving portions, when the first and second rods have been pulled against a biasing force of the biasing member whereby the ends of the first and second rods have been withdrawn from the first and second lock-receiving portions, respectively.

2. An interior apparatus of a vehicle according to claim 1, wherein the holding structure includes:
an engagement portion provided at at least one of the first and second rods;
an engagement-receiving portion provided at the movable member, the engagement portion being capable of engaging with and disengaging from the engagement-receiving portion; and
a movement structure for moving a rod at which the engagement portion is provided in a direction different from the rod-extending direction and in a direction in which the engagement portion and the engagement-receiving portion are brought into engagement with each other when the first and second rods are being withdrawn from the first and second lock-receiving portions, respectively.

3. An interior apparatus of a vehicle according to claim 2, wherein the lock device further includes a releasing structure for releasing a holding state by the holding structure, by moving the rod at which the engagement portion is provided in a direction in which engagement of the engagement portion with the engagement-receiving portion is released, when the movable member is being moved from the open position to the closed position.

4. An interior apparatus of a vehicle according to claim 3, wherein the releasing structure includes:
a first releasing structure element provided at the rod at which the engagement portion is provided; and
a second releasing structure element provided at the fixed member, the second releasing structure element being brought into contact with the first releasing structure element when the movable member is being moved from the open position to the closed position.

5. An interior apparatus of a vehicle according to claim 2, wherein the engagement portion of the holding structure is provided only at one of the pair of rods, and
wherein the lock device further includes a displacement structure for displacing the other of the pair of rods at which the engagement portion is not provided in a direction different from the rod-extending direction relative to the movable member, while the ends of the first and second rods have been withdrawn from the first and second lock-receiving portions against a biasing force of the biasing member.

6. An interior apparatus of a vehicle according to claim 2, wherein the movement structure of the holding structure includes a first movement structure element elastically deformably provided at one of the rod and the movable member and a second movement structure element provided at the other of the rod and the movable member, where the engagement portion is provided at the rod and the engagement-receiving portion is provided at the movable member, and
wherein by causing the first movement structure element to slide onto the second movement structure element, the rod at which the engagement portion is provided is moved in the direction different from the rod-extending direction and in the direction in which the engagement portion is engaged with the engagement-receiving portion.

7. An interior apparatus of a vehicle according to claim 3, wherein the rod at which the engagement portion is provided is moved by the movement structure of the holding structure in a direction perpendicular to direction D1 in which the movable member is moved relative to the fixed member when the movable member is moved from the open position to the closed position and arrives at the closed position,
wherein the rod at which the engagement portion is provided is moved by the releasing structure in the direction perpendicular to the direction D1 whereby the holding state of the holding structure is released by the releasing structure, and
wherein a space exists between the fixed member and the rod at which the engaging portion is provided when the holding state by the holding structure is released by the releasing structure.

8. An interior apparatus of a vehicle according to claim 2, wherein the lock device further includes a push-type knob provided at the movable member,
wherein the movement structure of the holding structure includes a first rotational structure element provided at the rod at which the engagement portion is provided and a second rotational structure element provided at the push-type knob, and
wherein the rod at which the engagement portion is provided is rotated by an operating force added on the knob in a direction in which the engagement portion and the engagement-receiving portion are engaged with each other.
